(19) United States
(12) Patent Application Publication
(10) Pub. No.: US 2026/0277563 A1
(43) Pub. Date: Sep. 17, 2026

(54) IDENTIFYING RELEVANT CODE RESOURCE DATA FOR CODE GENERATION USING ENHANCED DATA RETRIEVAL

(71) Applicant: Microsoft Technology Licensing, LLC, Redmond, WA (US)

(72) Inventors: Mukul SINGH, Seattle, WA (US); Sumit GULWANI, Sammamish, WA (US); Avik DUTTA, East Singhbhum (IN); Vu Minh LE, Redmond, WA (US); Gust Ben Anneloes VERBRUGGEN, Vlaams-Braban (BE)

(21) Appl. No.: 19/080,711

(22) Filed: Mar. 14, 2025

(51) Int. Cl. G06F 8/35

(52) U.S. Cl. CPC G06F 8/35

(57) ABSTRACT

Methods, computer systems, and computer storage media are provided for identifying relevant code resource data for code generation using enhanced data retrieval. In embodiments, a first set of code resource data relevant to an input is identified from a first corpus of code resource data. Thereafter, the input and the first set of code resource data are used to identify, from a second corpus of code resource data, a second set of code resource data relevant to the input and the first set of code resource data. An indication of the input, the first set of code resource data, and the second set of code resource data is used by one or more generative artificial intelligence models to generate code relevant to the input. Such generated code may be provided for display and/or implemented to execute a desired task or functionality indicated in the input.

### BACKGROUND

Automated code generation oftentimes results in the generation of ineffective code. In particular, the data used to facilitate generation of effective code may not be optimal. For example, in some cases, more optimal data to use for code generation may not exist or may be difficult to identify as relevant for use in generating code. As such, to identify a relevant or particular portion of available data associated with a programming language to use for generating code is very difficult and time-consuming. For example, the amount of data to review may be extensive with numerous details provided for each programming language. Further, code documentation may contain irrelevant and duplicative information, thereby adding to the complexity of identifying relevant information for generating code. Aspects of the code that may relate to one another to enable a more effective code generation may also be difficult to identify and use suitably.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for embodiments described herein facilitate identifying suitable or relevant code resource data in an efficient and effective manner to use for generating code. To identify relevant code resource data, in embodiments, an enhanced data retrieval process may be employed. An enhanced data retrieval process may include a sequential retrieval approach that leverages outputs of an initial retriever, also referred to herein as a driver retriever, to guide or focus a secondary retriever, also referred to herein as an influenced retriever. Such a sequential retrieval approach enhances the quality of the retrieved code resource data that may be used for code generation. In this way, the identified relevant code resource data may be provided in a prompt for an artificial intelligence (AI) model, such as a large language model (LLM), to evaluate and provide a response indicating generated code. Using an appropriate, relevant, or comprehensive set of code resource data for generating code enables a more computationally efficient and effective implementation.

### BRIEF DESCRIPTION OF DRAWINGS

The technology described herein is described in detail below with reference to the attached drawing figures, wherein:

FIG. 1 is a block diagram of an exemplary system for identifying relevant code resource data and using such data to generate code, suitable for use in implementing aspects of the technology described herein;

FIG. 2 is an example implementation for identifying relevant code resource data and using such data to generate code, in accordance with aspects of the technology described herein;

FIG. 3 provides an example prompt that may be used to obtain queries that resemble human-provided queries, in accordance with embodiments described herein;

FIG. 4A provides an example prompt to generate code, in accordance with aspects of the technology described herein;

FIG. 4B provides another example prompt for code generation, in accordance with aspects of the technology described herein;

FIG. 5 provides an example flow diagram of one implementation for identifying relevant code resource data for code generation, in accordance with aspects of the technology described herein;

FIG. 6 provides an example method flow for identifying relevant code resource data and generating code therefrom, in accordance with embodiments described herein;

FIG. 7 provides another example method flow for identifying relevant code resource data and generating code therefrom, in accordance with embodiments described herein;

FIG. 8 provides another example method flow for identifying relevant code resource data and generating code therefrom, in accordance with embodiments described herein;

FIG. 9 is a block diagram of an exemplary computing environment suitable for use in implementing aspects of the technology described herein; and

FIG. 10 is a block diagram of an exemplary large language model environment suitable for use in implementing aspects of the technology described herein.

### DETAILED DESCRIPTION

The technology described herein is described with specificity to meet statutory requirements. However, the description itself is not intended to limit the scope of this patent. Rather, the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

Code generation is oftentimes a challenging task due to the complexities of various programming languages and the difficulty of understanding and expressing logical problem-solving in a formal way. For example, code specifications or requirements may be vague or incomplete, resulting in ineffective code generation. As another example, programming languages generally have different syntax rules, data structures, libraries, etc., which can also result in ineffective code generation.

More recently, language models, such as large language models, have been used to facilitate code generation. Language models, however, oftentimes struggle to generate correct code for various programming languages. In particular, language models oftentimes do not generate correct code for low-resource programming languages, as such low-resource programming languages are underrepresented in the training data used to train the language models. As such, in conventional implementations, code examples have been used in an effort to improve the performance of these models. In this way, to generate code in a particular programming language, a language model may be supplemented with a code example(s) associated with the particular programming language.

Using code examples as context for code generation, however, may result in inadequate code. For example, code examples often do not include how components are actually pieced together in the form of programming code, thereby making it difficult for language models to understand the syntax and usage, particularly for newer or lower-resourced programming languages (e.g., lesser-used or implemented programming languages). As another example, code examples, or other documentation, may be weakly correlated to a natural language utterance, and particular portions of the examples or documentation might not be related at all to the utterance, but may be crucial for code generation. For instance, the query “Highlight the top 5 projects based on sales” requires a flag “OrderByDescending” to be set, but such a flag is not related to the query. As yet another example, code examples or other documentation may be dense and/or flat and, as such, result in difficulty in selecting a suitable subset of the information for use in generating code.

As such, while using code examples or other code documentation as context for code generation may be valuable to generate code, identification of such suitable data may be difficult and tedious. For example, an extensive amount of code examples or other code documentation may exist, making it difficult to identify valuable data to use in code generation. In addition to the extensive volume of data, identifying effective code examples or other code documentation may be difficult due to a variety of factors, such as context ambiguity, language-specific nuances, version compatibility, dependency management, and handling various types of edge cases. As such, identifying code examples or other documentation for use in performing code generation is tedious, time-consuming, and error-prone.

Further, such conventional implementations may unnecessarily consume computing resources. For instance, identifying ineffective code examples or other code documentation and using such ineffective data in a prompt to generate code can result in both unnecessary resources of computational time and memory when an AI model processes or generates code that is inefficient, irrelevant, or unnecessarily complex. For example, in cases in which code examples provided in a prompt are ineffective, overly complex, or suboptimal, the AI model may generate outputs based on inefficient algorithms or coding practices, thereby requiring more computational power to execute or simulate than a more optimized solution. Inefficient code generally includes unnecessary computations or memory usage, such as redundant loops, unoptimized data structures, or excessive use of resources (e.g., unneeded database queries or file operations). As another example, ineffective code examples or documentation often lead to prompts that confuse an AI model, which may cause the AI to generate an overly verbose, irrelevant, or extraneous content, thereby resulting in an increase in overall resource consumption to produce such extraneous output. As yet another example, ineffective code examples may be overly complex, leading to unnecessary complexity in the generated content. Overcomplicated code may require more CPU cycles to run and can lead to more memory usage (e.g., storing large amounts of intermediate data or performing unneeded calculations). As yet another example, ineffective code examples or poorly structured documentation can result in vague prompts that lead the AI model to spend unnecessary time figuring out the core intent of the request. As such, the AI model may have to generate multiple responses or iterate over several possible outputs to provide a suitable response, thereby consuming additional processing power. Further, ineffective examples or documentation may result in outputs that require substantial post-processing (e.g., refactoring code, removing extraneous content, cleaning up inefficient documentation, etc.) to make them usable. In addition to the resource consumption, without focusing on suitable or relevant data for use in generating code, an AI model may produce hallucinations, thereby resulting in ineffective or inefficient code.

As such, embodiments described herein facilitate identifying suitable or relevant code resource data in an efficient and effective manner to use for generating code. In this way, the identified relevant code resource data may be provided in a prompt for an AI model, such as an LLM, to evaluate and provide a response indicating generated code. Using an appropriate, relevant, or comprehensive set of code resource data for generating code enables a more computationally efficient and effective implementation.

To identify relevant code resource data, in embodiments, an enhanced data retrieval process may be employed. An enhanced data retrieval process may include a sequential retrieval approach that leverages outputs of an initial retriever, also referred to herein as a driver retriever, to guide or focus a secondary retriever, also referred to herein as an influenced retriever. Such a sequential retrieval approach enhances the quality of the retrieved code resource data that may be used for code generation. By way of example only, using an enhanced data retrieval process described herein, a particular type of code resource data (e.g., code examples) is used to identify a first relevant set of code resource data. The first relevant set of code resource data is then used to search another type of code resource data (e.g., grammar entities) to identify a second relevant set of code resource data. The first and second relevant sets of code resource data (e.g., code examples and grammar entities) may then be input or included in a prompt to facilitate generation of code using the first and second relevant sets of code resource data. Although various embodiments described herein refer to a retrieval augmented retrieval (RAR) approach as a two-step retrieval process for selecting relevant code resource data (e.g., relevant code examples and grammar entities), any number of sequential steps may be performed to select data. For example, in some cases, three different types of code resource data may be used and, in such cases, three sequential steps may be performed to select relevant data from each of the different types of code resource data.

Although various examples described herein refer to identifying and using code examples and code grammar entities, various types of code resource data may be accessed and used to generate code. Examples of types of code resource data include various types of practical data, descriptive data, contextual data, organizational data, metadata, etc. Practical data may include code examples, test data, and use cases. Descriptive data may include grammar entities, guides, problem statements, etc. Contextual data may include business logic, user requirements, etc. Organizational data may include code patterns, design principles, etc. Metadata may include dependencies, performance, versioning, etc. In some examples, code documentation may include various types of code resource data. Code documentation may exist for various types of programming languages. In some cases, code documentation may include code examples (e.g., depict how to use and combine elements, for example, of grammar entities) and grammar entities (e.g., that describe how code is built or used, for example, in association with various entities of classes, methods, properties, etc.). In this way, grammar entities refer to various components or units that make up the structure of a grammar. Such entities may represent or define syntax and rules for how symbols can be combined to form valid structures. As such, grammar entities help define the structure and rules of programming languages. Grammar entities may include, for example, non-terminals, terminals, production rules, start symbols, syntax entities or constructs, lexical entities or tokens, context-free grammar entities, etc.

In accordance with identifying relevant code resource data, for example using an enhanced data retrieval approach described herein, such identified relevant code resource data may be used to generate a prompt for input into an AI model, such as a generative AI model or an LLM, to produce a response including generated code. In addition to the identified relevant code resource data, the prompt may also include the user query or natural language input, among other things. Based on the input prompt, a response may be obtained indicating code generated in association with the code resource data. In this way, relevant code resource data, such as code examples and grammar entities, is used to generate code, thereby resulting in effective and efficient code generation for performing a desired function. For instance, by accurately identifying relevant code resource data, a more desired, efficient, and suitable set of code is generated. The generated code may then be provided, for example, to a user of a user device or another component for further analysis and/or implementation to execute a desired functionality or feature, thereby enhancing a user experience.

### Overview of Exemplary Environments for Identifying Relevant Code Resource Data for Code Generation Using Enhanced Data Retrieval

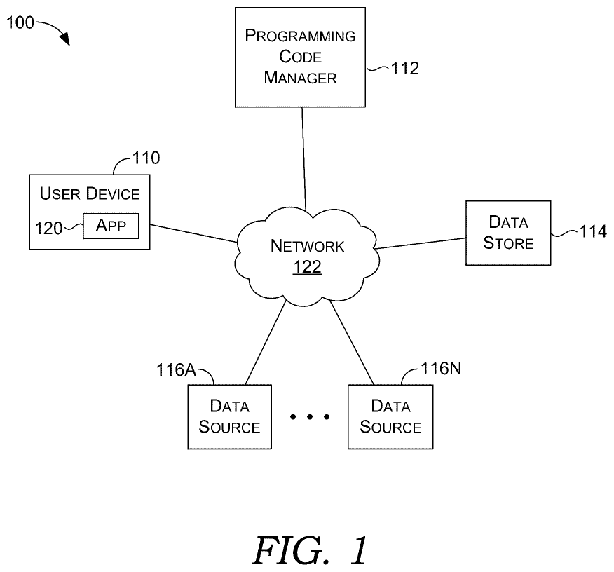

Referring initially to FIG. 1, a block diagram of an exemplary network environment 100 suitable for use in implementing embodiments described herein is shown. Generally, the system 100 illustrates an environment suitable for identifying relevant code resource data for use in code generation. Among other things, embodiments described herein efficiently and effectively identify relevant code resource data using an enhanced data retrieval approach in an automated manner. To do so efficiently and effectively, a first set of relevant code resource data is identified and used for identifying a second set of relevant code resource data. Generally, the first set of relevant code resource data corresponds with one type of data, and the second set of relevant code resource data corresponds with a different type of data. Identifying relevant code resource data reduces the set of data to be analyzed and provides an appropriate set of data best suited for generating code. Further, identifying one type of code source data based on, or dependent on, identifying relevant code source data associated with a different data type enables a correlation between the data such that the data is relevant to one another. In accordance with identifying a set of relevant code source data associated with a first type of code source (e.g., code examples) and associated with a second type of code source (e.g., grammar entities), such data may be used to generate code, for example, using AI technology. For instance, a prompt may be generated that includes the relevant code source data (e.g., code examples and grammar entities relevant to one another and an input, such as a natural language query) such that the relevant code source data is analyzed by AI, such as an LLM, to generate code. In this way, effective code may be efficiently generated in a manner suitable to achieve a desired functionality.

The network environment 100 includes a user device 110, a programming code manager 112, a data store 114, and data sources 116a-116n (referred to generally as data source[s] 116). The user device 110, the programming code manager 112, the data store 114, and the data sources 116a-116n can communicate through a network 122, which may include any number of networks such as, for example, a local area network (LAN), a wide area network (WAN), the Internet, a cellular network, a peer-to-peer (P2P) network, a mobile network, or a combination of networks. The data store 114 may store any type or amount of data, including data accessible to the user device 110, the programming code manager 112, and/or the data sources 116. For example, the data store 114 may store code resource data, relevant code resource data, generated code, etc.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. For example, the user device 110 and data sources 116a-116n may be in communication with the programming code manager 112 via a mobile network or the Internet, and the programming code manager 112 may be in communication with data store 114 via a local area network. Further, although the environment 100 is illustrated with a network, one or more of the components may directly communicate with one another, for example, via HDMI (High-Definition Multimedia Interface) and DVI (Digital Visual Interface). Alternatively, one or more components may be integrated with one another, for example, at least a portion of the programming code manager 112 and/or data store 114 may be integrated with the user device 110. For instance, a portion of the programming code manager 112 may be integrated with the user device (e.g., via application 120).

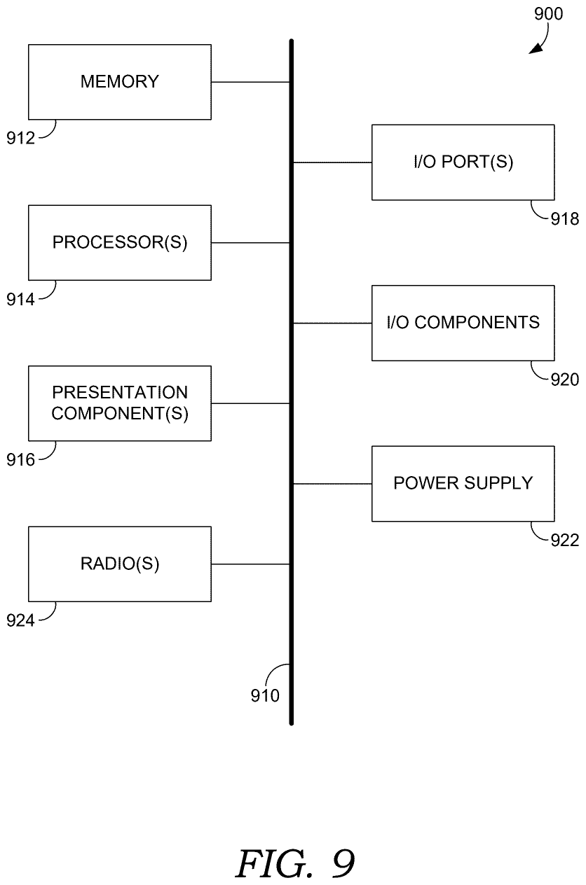

The user device 110 can be any kind of computing device capable of facilitating the identification of relevant code resource data and/or generation of code. For example, in an embodiment, the user device 110 can be a computing device such as computing device 900, as described above with reference to FIG. 9. In embodiments, the user device 110 can be a personal computer (PC), a laptop computer, a workstation, a mobile computing device, a PDA, a cell phone, or the like.

The user device can include one or more processors and one or more computer-readable media. The computer-readable media may include computer-readable instructions executable by one or more processors. The instructions may be embodied by one or more applications, such as application 120 shown in FIG. 1. The application(s) may generally be any application capable of facilitating the identification of relevant code resource data and/or generation of code. Capabilities to identify relevant code resource data and/or generate code may be integrated into a variety of applications across various domains, for example, to enhance productivity, facilitate decision-making, and efficiently automate tasks. Examples of applications may include code editors and integrated development environments, productivity tools and office suites, customer relationship management (CRM) systems, project management software, collaboration platforms, content creation tools, e-commerce platforms, data analysis and business intelligence tools, healthcare applications, or the like. In this regard, in some cases, technology described herein may be used in association with code development and management applications. In other cases, technology described herein may be used in association with other types of applications for which code generation may be desired. In yet other cases, technology described herein may be incorporated into an operating system or other system to generate suitable code for a computing device, network, system, application, or the like. Any of such applications may include or access an AI assistant tool or technology that may facilitate code generation. As such, application 120 may be any type of application that may facilitate identification of relevant code resource data and/or generation of code. In some implementations, the application(s) comprises a web application, which can run in a web browser, and may be hosted at least partially server-side (e.g., via programming code manager 112). In addition, or instead, the application(s) can comprise a dedicated application. In some cases, the application is integrated into the operating system (e.g., as a service).

User device 110 can be a client device on a client-side of operating environment 100, while programming code manager 112 can be on a server-side of operating environment 100. Programming code manager 112 may comprise server-side software designed to work in conjunction with client-side software on user device 110 so as to implement any combination of the features and functionalities discussed in the present disclosure. An example of such client-side software is application 120 on user device 110. This division of operating environment 100 is provided to illustrate one example of a suitable environment, and it is noted that there is no requirement for each implementation that any combination of user device 110 and/or programming code manager 112 remain as separate entities.

In an embodiment, the user device 110 is separate and distinct from the programming code manager 112, the data store 114, and the data sources 116 illustrated in FIG. 1. In another embodiment, the user device 110 is integrated with one or more illustrated components. For instance, the user device 110 may incorporate functionality described in relation to the programming code manager 112. For clarity of explanation, embodiments are described herein in which the user device 110, the programming code manager 112, the data store 114, and the data sources 116 are separate, while understanding that this may not be the case in various configurations contemplated.

As described, a user device, such as user device 110, can facilitate identification of relevant code resource data in an effective and efficient manner, and such relevant code resource data can then be used to generate effective code. Code resource data generally refers to data that can be used as a resource to generate or explain code (e.g., in a structured way). In embodiments, code resource data may be obtained from code documentation, which may include code examples, grammar entities, etc. Code documentation may be a comprehensive and structured resource and, in some cases, publicly available for various programming languages. An example of code documentation may include a grammar entity that describes how code is built over entities (classes, methods, properties, etc.) and examples that depict how to use and combine elements from grammar entities. Identifying the most relevant code resource data enables more suitable and effective code to be generated. In this regard, understanding and identifying relevant code resource data and different types of relevant code resource data that are correlated or related to one another may be critical for optimizing generation of code. As such, identifying relevant code resource data in an efficient and effective manner facilitates a more productive and effective code generation (e.g., in association with task or functionality for an application). Embodiments described herein enable the programming code manager 112 to identify relevant code resource data and use such relevant code resource data to generate code in an efficient and effective manner.

A user device 110, as described herein, is generally operated by an individual or entity interested in initiating code generation. In some cases, identification of relevant code resource data and/or code generation may be initiated at the user device 110. For instance, in some cases, a user may navigate to an AI tool interface (e.g., a chat box) and input a request to perform a particular task or functionality or generate code in association therewith. As one example, the user input may include or be a natural language input by a user. A user input may include a request in the form of a question, command, or description of a desired task to be performed or code to be generated. Based on the input, identification of relevant code resource data and/or generation of code is initiated. For example, a user may navigate to an application and input a request to perform a particular task (e.g., sort data in a certain manner, modify data, modify graphical display of certain data, etc.) in association with the application, or to generate code associated therewith.

As described, the user device 110 can include any type of application, which may be a stand-alone application, a mobile application, a web application, or the like. In some cases, the functionality described herein may be integrated directly with an application or may be an add-on, or plug-in, to an application.

The user device 110 may communicate with the programming code manager 112 to initiate identification of relevant code resource data and/or generation of code. In embodiments, for example, a user may utilize the user device 110 to initiate identification of relevant code resource data and/or generation of code via the network 122. For instance, in some embodiments, the network 122 may be the Internet, and the user device 110 interacts with the programming code manager 112 to initiate identification of relevant code resource data and/or generation of code. In other embodiments, for example, the network 122 may be an enterprise network associated with an organization. In yet other embodiments, the programming code manager 112 may additionally or alternatively operate locally on the user device 110 to provide local responses. It should be apparent to those having skill in the relevant arts that any number of other implementation scenarios may be possible as well.

With continued reference to FIG. 1, the programming code manager 112 can be implemented as server system(s), program module(s), virtual machine(s), component(s) of a server or servers, networks, and the like. At a high level, the programming code manager 112 manages identification of relevant code resource data and/or generation of code. In embodiments, at a high level, to generate code relevant to an input (e.g., a natural language utterance or query), relevant code resource data is identified and used to generate code (e.g., via an LLM). To determine relevant code resource data, an initial set of code resource data (e.g., associated with a particular type of code resource data) is accessed and used to identify a first set of code resource data relevant to the input. Using the identified relevant code resource data from the initial set of code resource data, a secondary set of code resource data (e.g., associated with a different type of code resource data) is accessed and used to identify a second set of code resource data relevant to the input. As such, the second set of code resource data is relevant to the input and to the first set of identified relevant code resource data. Both the first set of relevant code resource data and the second set of relevant code resource data can then be used to generate code in accordance with the input.

Code resource data that is analyzed for relevance may be obtained from various data sources, such as data sources 116. For example, one data source may include code resource data (e.g., via code documentation) associated with one type of programming code, while another data source may include code resource data associated with another type of programming code. As another example, one data source may include a first type of code resource data (e.g., code examples), while another data source may include code resource data associated with a second type of code resource data (grammar entities). As yet another example, one data source may include a first portion of code resource data (e.g., a first code documentation), while another data source may include a second portion of resource data (e.g., a second code documentation). Such code resource data may be in any number of formats. As such, data sources 116 may include various code resource data, such as code examples, grammar entities, etc. In accordance with obtaining code resource data, such data may be stored in data store 114. In some cases, the data may be stored in a particular manner. For instance, code resource data associated with a particular type of programming code may be stored separate from code resource data associated with another type of programming code. As another example, various types of code resource data may be stored separately.

By way of example only, assume a user provides an input to request to perform a task or generate code for a task. In such a case, to generate effective code to perform the task, embodiments described herein facilitate the identification of relevant code resource data to use to generate suitable code. To do so, a set of example code may be analyzed to identify example code relevant to the input. In some cases, a similarity analysis may be performed to identify example code relevant to the input. Upon obtaining relevant example code, a set of grammar entities may be analyzed to identify grammar entities relevant to the identified relevant example code. In this way, the identified relevant grammar entities are relevant to both the input as well as the identified relevant example code. Such a dependency on relevant code examples enables selection or identification of grammar entities that are correlated with the code examples, thereby enabling generation of a more productive or effective code.

To generate code, a prompt may be generated for input into an AI agent, such as an LLM, to provide a response including code produced in association with the input. Advantageously, the prompt may include the identified relevant code resource data (e.g., identified in association with different types of code resource data). Based on the input prompt, a response may be generated that indicates code for use in performing a desired task. The programming code manager 112 may then communicate with application 120 operating on user device 110 to provide an indication of the generated code and/or to implement the generated code. For example, an indication of generated code may be provided to the user device for presentation to the user. An indication of code may be presented to a user via a user interface associated with application 120 in any number of ways. Additionally or alternatively, such generated code may be implemented, for example, to perform the desired functionality requested by the user.

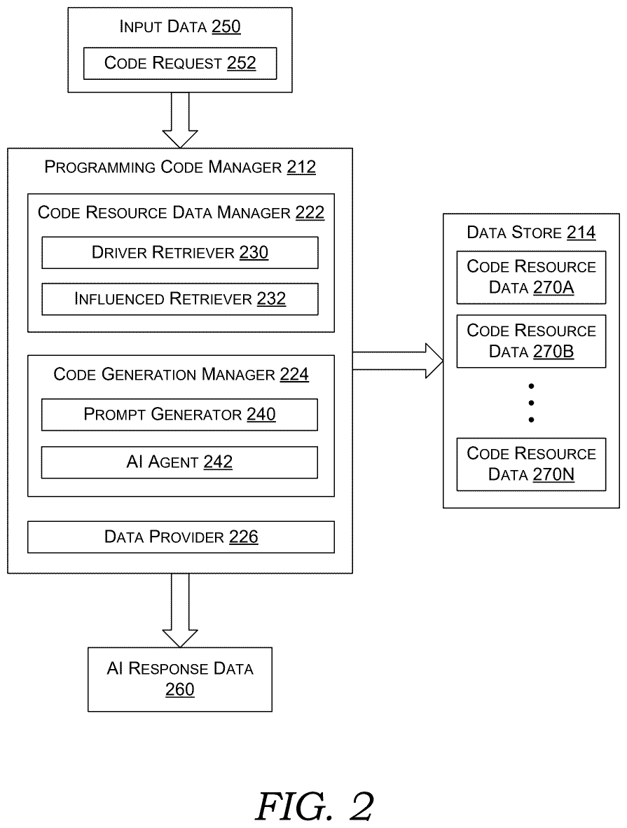

Turning now to FIG. 2, FIG. 2 illustrates an example implementation for identifying relevant code resource data and/or utilizing relevant code resource data to generate code via programming code manager 212. The programming code manager 212 is communicatively coupled with the data store 214. The data store 214 is configured to store various types of information accessible by the programming code manager 212 or other server or device. In embodiments, data sources (such as data sources 116 of FIG. 1), user devices (such as user devices 110 of FIG. 1), and/or a programming code manager (such as programming code manager 212) can provide data to the data store 214 for storage, which may be retrieved or referenced by any such component. As such, the data store 214 may store code resource data, user queries, natural language utterances, generated code, and/or the like. In embodiments, various types of code resource data 270 may be stored in data store 214. For example, and as illustrated, a first set of code resource data 270A and a second set of code resource data 270B through N code resource data 270N may be stored in data store 214.

In operation, the programming code manager 212 is generally configured to manage identifying relevant code resource data and/or using relevant code resource data to generate code in an efficient and effective manner. In embodiments, the programming code manager 212 includes a code resource data manager 222, a code generation manager 224, and a data provider 226. According to embodiments described herein, the programming code manager 212 can include any number of other components not illustrated. In some embodiments, one or more of the illustrated components 222, 224, and 226 can be integrated into a single component or can be divided into a number of different components. Components 222, 224, and 226 can be implemented on any number of machines and can be integrated, as desired, with any number of other functionalities or services.

Turning initially to the code resource data manager 222, the code resource data manager 222 is generally configured to manage identification of relevant code resource data. As described, identifying relevant code resource data enables a more efficient and effective generation of code. Code resource data refers to any data that may be used to generate code. Code resource data may include, for example, code examples and grammar entities, among other types of data (e.g., included within code documentation). Code resource data may be identified as relevant based on an input. In this regard, relevant code resource data is identified in association with an obtained input (e.g., via a user device, such as user device 110 of FIG. 1).

At a high level, identification of relevant code resource data may be initiated in any number of ways. In some cases, such identification may be initiated based on the programming code manager 212, or another component such as the code resource data manager 222, receiving a code request 252 as input data 250 that requests generation of code. In some embodiments, a code request may be obtained at the programming code manager 212 based on user input. For example, a user operating a user device may provide input (e.g., in the form of a query or natural language utterance) or select to initiate generation of code. In such cases, the user may provide an indication of code desired to be generated. For example, the user may specify a particular type of task or functionality desired to be performed (e.g., a data analysis or data transformation desired to be performed). Additionally or alternatively, the user may specify a particular type of programming code to use and/or the like. Further, in some cases, a user may specify a particular type(s) of code resource data to use. For instance, a user may select or indicate a first type of code resource data, such as example code, and a second type of code resource data, such as grammar entities.

Such user-provided input may be provided via an input text box in a user interface associated with an application executing at the user device. As one example, an input text box may correspond with an AI agent. In this regard, a field or region may be provided in a user interface that is connected or linked to an AI agent, such as a chatbot, virtual assistant, etc., such that the text input (e.g., a question, command, or other natural language utterance) from the user may be processed by the AI agent to generate a response or action based on the provided input. Although described as text input, other types of input may be provided. For instance, a verbal input may be provided to trigger or initiate code generation.

Additionally or alternatively, a code request, such as code request 252, may be automatically triggered based on an occurrence of an event. For example, in accordance with attempting to perform or requesting a particular task in association with an application operating on a user device, a code request may be automatically triggered to initiate generation of code to perform the task. As another example, in accordance with expiration of a time duration (e.g., one day, one week, or the like), a code request may be automatically triggered to initiate identification of relevant code resource data and/or generation of code.

In accordance with initiating identification of relevant code resource data, the code resource data manager 222 is generally configured to manage identification of relevant code resource data. To do so, in some embodiments, the code resource data manager 222 may include a driver retriever 230 and an influenced retriever 232 to perform an enhanced code resource data identification. In this way, the driver retriever 230 may obtain initial relevant code resource data, which may in turn be used by the influenced retriever 232 to obtain additional relevant code resource data. Such an enhanced, or dependent, data retrieval process enables identification of more relevant data for use in generating code.

The driver retriever 230 is generally configured to obtain or retrieve relevant code resource data. In this regard, the driver retriever 230 may obtain code resource data that is relevant to an input, such as code request 252. In embodiments, the driver retriever 230 identifies relevant data associated with an initial or particular code resource type. Such an initial or particular code resource type is the code resource type used to initially identify relevant data, which is then used as a basis for identifying relevant data of another code resource type. An initial or particular code resource type may be any type of code resource, such as code examples or grammar entities. As one example, in cases in which code examples are designated as the initial type of code resource, the driver retriever 230 may identify relevant code examples from a code example corpus.

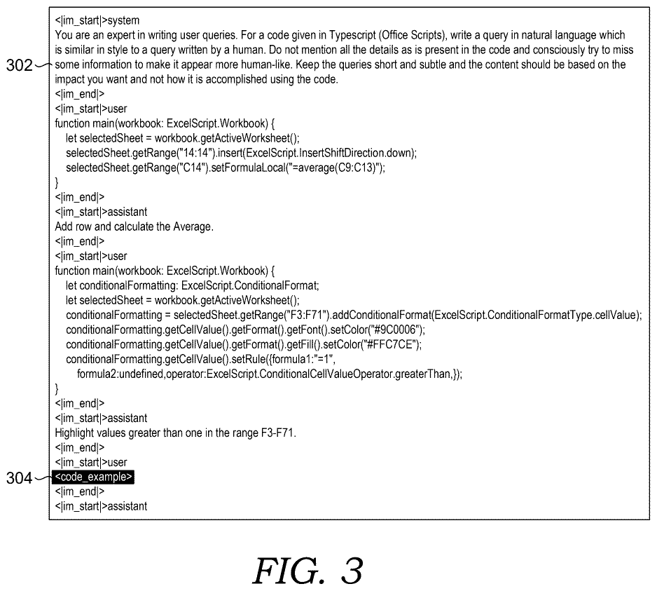

A code example corpus generally includes a set of code examples. In this way, the code example corpus may be searched to identify code examples relevant to an input (e.g., a natural language utterance). A code example may be defined or represented in any number of ways. As one example, a code example may be represented via a query-code pair. In this regard, a code example may include a query, such as a natural language query or utterance, and a corresponding portion of code. In embodiments, code examples may be obtained for a code example corpus in any number of ways. In some cases, the code examples may be provided by various programmers or managers. In other cases, code examples may be identified via the Internet or other collection of data. In yet other cases, code examples may be obtained from documentation, which may be scraped, for example, using regular expressions. Such documentation, however, may not include corresponding inputs or queries (e.g., Office Scripts language). Accordingly, in some embodiments, queries for a code example including a query-code pair may be generated. One manner for generating queries for a query-code pair includes using an LLM. FIG. 3 provides an example prompt that may be used to obtain queries that resemble a human as much as possible. FIG. 3 provides an example prompt 302 that may be used for generation of human-like natural language queries for Office Scripts. The <code_example> 304 indicates where the code examples extracted from the documentation may be included for which the natural language query needs to be generated.

As another example, in cases in which grammar entities are designated as the initial type of code resource, the driver retriever 230 may identify relevant grammar entities from a grammar corpus. A grammar corpus generally includes a set of grammar entities. A grammar entity generally represents a function or information associated therewith (e.g., how to use a function). Grammar entities may be defined or represented in a grammar corpus in any number of ways. As one example, a grammar corpus may include grammar sets, with each grammar set including a page title and one or more corresponding grammar entities (e.g., P₁: <Page Title>; g₁: <grammar entity>1 g₂: <grammar entity>).

The particular type of code resource used to identify relevant code resource data may be established or determined in any number of ways. In some cases, the particular type of code resource data may be predetermined or designated. For instance, the driver retriever 230 may identify relevant code resource data in association with example code. In embodiments, the particular type of code resource may be predetermined or designated for a particular type of programming code. For instance, for a first type of programming code, a first type of code resource data (e.g., code samples) may be identified via the driver retriever 230, and for a second type of programming code, a second type of code resource data (e.g., grammar entities) may be identified via the driver retriever 230. The particular type of code resource data for a given programming code may be determined in any number of ways. For example, for a given programming language, the quality of data may vary and, as such, using different datasets may be explored to determine a particular set of code resource data to identify as relevant via the driver retriever 230. Alternatively or additionally, the particular type of code resource data may be dynamically determined or identified, for example, based on a natural language utterance or other input.

To identify relevant code resource data, the driver retriever 230 may perform a similarity analysis in association with an input (e.g., a natural language utterance or query) and a set of code resource data. To perform a similarity analysis, in some cases, embeddings may be utilized. Embeddings generally refer to high-dimensional vector representations of data (e.g., text, images, etc.) that capture the semantic content or features of the data. An embedding model may be used to generate an embedding for an input, such as a natural language utterance or query. Any embedding model may be used to generate embeddings. In some cases, a pre-trained embedding model may be used. Examples of pre-trained embedding models include Word2Vec, BERT, OpenAI's GPT, etc. Accordingly, the driver retriever 230, or another component, may facilitate generation (e.g., via an embedding model) of an embedding of an input.

In accordance with generating an embedding of an input, also referred to herein as an input embedding, the input embedding can be compared to embeddings of a particular set of code resource data to identify relevant code resource data. For example, an input embedding of a natural language utterance can be compared to a set of embeddings representing code examples in a code example corpus to identify code examples relevant to the input natural language utterance. As such, an embedding model, such as an embedding model used to generate an input embedding, may be used to generate embeddings for code resource data (e.g., in advance to be stored or dynamically in the real-time identification of relevant data). For example, in accordance with obtaining code resource data, an embedding model may be used to generate embeddings to represent such data (e.g., code examples or grammar entities). Using embeddings to perform a similarity analysis enables capturing of semantic meaning, handling variability in languages, efficient similarity comparison, handling of complex data types, and reducing dimensionality, among other things.

In performing a similarity analysis or comparison, the driver retriever 230 may use a metric to compare the embeddings, or vectors, and measure the similarity therebetween. As one example, cosine similarity may be used to measure the cosine of the angle between two vectors. As another example, Euclidean distance may be used to measure the straight-line distance between two points in the embedding space. As yet another example, a dot product may be used for measuring relevance or strength of similarity.

In some cases, such a similarity analysis may be performed by a same model that performs embedding. For example, transformer embedding cosine similarity may be performed that uses a transformer-based model to generate embeddings for text (e.g., input and/or code resource data) and then calculates the cosine similarity between embeddings. One example of a transformer embedding cosine similarity may be represented as:

$$S ( M , {q}_{1} , {q}_{2} ) = cos ( M ( {q}_{1} ) , M ( {q}_{2} ) )$$

wherein M represents the embedding model used to compute the similarity between strings q₁ and q₂. As described, in some cases, such a model may be pre-trained, M_{PT}. In other cases, such a model may be fine-tuned. Model fine-tuning may be used to account for low-resource languages. One example of a training dataset that may be used to fine-tune includes use of triplets (q, J(g), L(c,g)) forming a training set. J(g) maps a grammar entity to a textual representation. L(c,g) evaluates to 1 if g is used on code c and −1 otherwise. To select negative labels, grammar entities g that are not used in code c, but which are closer to the decision boundary according to similarity S(M_{PT}, q, J(g)) when compared with the text query are identified as well as an equal number of grammar entities that have the lowest similarities. In some cases, the training dataset may include a particular proportion of positive and negative labels, such as 1:2 respectively. Further, a validation dataset may be generated by sampling data from a benchmark.

The driver retriever 230 may obtain, identify, or retrieve any amount of relevant code resource data. As one example, in accordance with performing a similarity analysis to identify a set of relevant code resource data, the driver retriever 230 may identify the top-k examples or the top-n grammar entities (e.g., based on generated similarity scores). As another example, a set of relevant code resource data associated with similarity scores above a threshold may be identified or selected. In some cases, a number of relevant data or similarity threshold used to identify or select relevant code resource data may be predetermined or set in advance. In other cases, such an extent of relevant data may be dynamically determined, for example, based on a statistical model. Further, in some cases, the driver retriever 230 may identify positive (e.g., good or similar) and/or negative (e.g., bad or dissimilar) data as relevant to an input. For instance, similar and/or dissimilar code examples may be identified as relevant to a user query.

The influenced retriever 232 is generally configured to obtain or retrieve relevant code resource data based on relevant code resource data identified via the driver retriever 230. In this regard, the influenced retriever 232 performs data retrieval influenced using relevant code resource data identified via the driver retriever 230. In this way, the influenced retriever 232 can learn from the findings of the driver retriever 230 to facilitate identification of relevant code resource data. In particular, the influenced retriever 232 generally obtains or identifies relevant code resource data based on data obtained or identified as relevant by the driver retriever 230.

Generally, and as described herein, the influenced retriever 232 identifies code resource data associated with a different type of code resource data than is identified by the driver retriever. In this way, two different types of code resource data can be identified and used to generate code. Advantageously, the type of code resource data identified as relevant by the influenced retriever 232 is dependent on, or influenced by, the type of code resource data identified as relevant by the driver retriever 230. Accordingly, based on the first retrieved data, the influenced retriever 232 can identify relevant data of a different data type. As one example, assume the driver retriever 230 identifies relevant grammar entities. In such a case, the relevant grammar entities can be used by the influenced retriever 232 to identify relevant data of another code resource data type, such as code examples. As another example, assume the driver retriever 230 identifies relevant code examples. In such a case, the relevant code examples can be used by the influenced retriever 232 to identify relevant data of another code resource data type, such as grammar entities. For instance, assume the driver retriever 230 identifies a code example that uses a filter function. In such a case, the influenced retriever 232 can analyze grammar entities to identify documentation related to the filter function. In this way, using both types of relevant data to generate code can facilitate using the documentation to recognize what might need to be changed in association with the filter function. Advantageously, using a sequential or influenced approach to identifying relevant data enables relevance between the different types of information.

The particular code resource type analyzed to identify relevant code resource data in association with the influenced retriever 232 may be of any type of code resource, such as code examples or grammar entities. As one example, in cases in which code examples are designated as the type of code resources referenced by the influenced retriever 232, the influenced retriever 232 may identify relevant code examples from a code example corpus (e.g., via data store 214). In this way, a code example corpus may be searched to identify code examples relevant to an input (e.g., a natural language utterance) in association with one or more relevant code resource datasets (e.g., grammar entities) identified by the driver retriever 230. As another example, in cases in which grammar entities are designated as the type of code resources referenced by the influenced retriever 232, the influenced retriever 232 may identify relevant grammar entities from a grammar entity corpus (e.g., via data store 214). In this way, a grammar entity corpus may be searched to identify grammar entities relevant to an input (e.g., a natural language utterance) in association with one or more relevant code resource datasets (e.g., code examples) identified by the driver retriever 230.

The particular type of code resource used to identify relevant code resource data in association with the influenced retriever 232 may be established or determined in any number of ways. In some cases, the particular type of code resource data may be predetermined or designated. For instance, the influenced retriever 232 may identify relevant code resource data in association with example code. In embodiments, the particular type of code resource may be predetermined or designated for a particular type of programming code. For instance, for a first type of programming code, a first type of code resource data (e.g., code samples) may be identified via the influenced retriever 232, and for a second type of programming code, a second type of code resource data (e.g., grammar entities) may be identified via the influenced retriever 232. The particular type of code resource data for a given programming code may be determined in any number of ways. For example, for a given programming language, the quality of data may vary and, as such, using different datasets may be explored to determine a particular set of code resource data to identify as relevant via the influenced retriever 232. Alternatively or additionally, the particular type of code resource data may be dynamically determined or identified, for example, based on a natural language utterance or other input.

To identify relevant code resource data, the influenced retriever 232 may perform a similarity analysis in association with an input (e.g., a natural language utterance or query) and code resource data identified via the driver retriever 230 in comparison with a set of code resource data. In this way, the influenced retriever 232 identifies relevant code resource data in accordance with a previously identified relevant code resource data of a different type. Accordingly, the influenced retriever 232 may compare an input and code resource data identified via the driver retriever 230 to a different type of code resource data (e.g., stored in data store 214) to identify which of the code resource data of the different type is deemed relevant.

To perform a similarity analysis, in some cases, embeddings may be utilized. As described, an embedding model may be used to generate an embedding for an input, such as a natural language utterance or query, and/or previously identified relevant code resource data. Any embedding model may be used to generate embeddings. In some cases, the influenced retriever 232, or another component, may facilitate generation (e.g., via an embedding model) of an embedding. An embedding may represent an input and/or previously identified relevant code resource data in any number of ways. As one example, an embedding may be generated in association with each component or relevant code resource data. For example, assume the driver retriever 230 identifies a first code example, a second code example, and a third code example as being relevant to an input natural language utterance. In such a case, a first embedding may be generated that encodes the input natural language utterance and the first code example, a second embedding may be generated that encodes the input natural language utterance and the second code example, and a third embedding may be generated that encodes the input natural language utterance and the third code example. As another example, an embedding may encode each of the first code example, the second code example, and the third code example. In some cases, input embeddings may be separate from embeddings encoding code resource data. Further, in some cases, the influenced retriever 232 may only use embeddings of code resource data.

In accordance with generating an embedding (e.g., in association with input and/or previously identified code resource data), the embedding can be compared to embeddings of a particular set of code resource data to identify relevant code resource data. For example, an embedding encoding a natural language utterance and a previously identified grammar entity can be compared to a set of embeddings representing code examples to identify code examples relevant to the input natural language utterance and the previously identified grammar entity. In some cases, the set of embeddings representing code examples are stored in advance in the data store 214. In this way, the embeddings are generated, stored, and thereafter accessed to identify relevant data. In other cases, the embeddings representing the code examples may be generated (e.g., via an embedding model) in real time, that is, as identification of relevant code resource data is being performed. As such, an embedding model, such as an embedding model used to generate an embedding, may be used to generate embeddings for code resource data (e.g., in advance to be stored or dynamically in real-time identification of relevant data).

In performing a similarity analysis or comparison, the influenced retriever 232 may use a metric to compare the embeddings, or vectors, and measure the similarity therebetween. As one example, cosine similarity may be used to measure the cosine of the angle between two vectors. As another example, Euclidean distance may be used to measure the straight-line distance between two points in the embedding space. As yet another example, a dot product may be used for measuring relevance or strength of similarity. In some cases, such a similarity analysis may be performed by a same model that performs embedding. For example, transformer embedding cosine similarity may be performed that uses a transformer-based model to generate embeddings for text (e.g., input and/or code resource data) and then calculates the cosine similarity between embeddings.

The influenced retriever 232 may obtain, identify, or retrieve any amount of relevant code resource data. As one example, in accordance with performing a similarity analysis to identify a set of relevant code resource data, the influenced retriever 232 may identify the top-k examples or the top-n grammar entities (e.g., based on generated similarity scores). As another example, a set of relevant code resource data associated with similarity scores above a threshold may be identified or selected. In some cases, a number of relevant data or similarity threshold used to identify or select relevant code resource data may be predetermined or set in advance. In other cases, such an extent of relevant data may be dynamically determined, for example, based on a statistical model.

Further, in some cases, the influenced retriever 232 may identify positive (e.g., good or similar) and/or negative (e.g., bad or dissimilar) data. For example, code resource data that provides a negative influence may be identified. As one example implementation, assume a first code example, a second code example, and a third code example are identified by a driver retriever. The first code example may be used to identify a first relevant grammar entity based on a similarity analysis, the second code example may be used to identify a second relevant grammar entity, and the third code example may be used to identify a third relevant grammar entity. To identify a negative influential grammar entity, the first code example, the second code example, and the third code example may be combined to identify a negative influential grammar entity. In this way, the influenced retriever 232 may identify one or more grammar entities that are relevant to the user query but have a negative influence on the selected code examples.

As described herein, any number of influenced retrievers may be used, or an influenced retriever may obtain data associated with any number of types of code resource data. For example, a first influenced retriever may obtain data associated with one type of code resource data, while a second influenced retriever may obtain data associated with another type of code resource data. In some cases, the second influenced retriever may be influenced by the driver retriever and/or the first influenced retriever. As another example, a single influenced retriever may retrieve relevant data associated with one type of code resource data and retrieve relevant data associated with another type of code resource data.

Turning to the code generation manager 224, the code generation manager is generally configured to generate code. In particular, the code generation manager 224 uses code resource data identified as relevant via the driver retriever 230 and the influenced retriever 232 to generate code. As such, code is generated using multiple types of code resource data. Moreover, the code resource data used to generate code is effectively identified as relevant such that a more suitable code can be generated. The code generation manager 224 may generate code in any number of ways. In embodiments, the code generation manager 224 may include or use artificial intelligence (AI), machine learning, or any other technology to generate code using relevant code resource data. For example, the code generation manager 224 may use AI to generate code in accordance with one or more sets of relevant code resource data identified by the code resource data manager 222.

In one embodiment, the code generation manager 224 includes a prompt generator 240 and an AI agent 242 to generate code. At a high level, the prompt generator 240 may be configured to generate a prompt that is used as input to an AI agent 242 to provide a response including content generated based on relevant code resource data.

The prompt generator 240 is generally configured to generate a prompt that is used, as input, to an AI agent. A prompt, or input prompt, generally refers to a request for data from which an AI response may be generated. In this regard, a prompt may be used to retrieve relevant information, perform specific tasks, or provide accurate responses based on the input prompt. In some cases, a prompt is generated by the prompt generator 240 based on a user's input or request (e.g., code request). In this way, a request or query input by a user may provide a basis for formulating an instruction of a prompt. In this way, the prompt generator 240 may use the code request 252 of the input data to derive an instruction for the prompt. For example, the prompt generator 240 may take as input the code request, or a portion thereof, and perform additional processing or refinement of the request to convert the request or generate a prompt in a format that is suitable for the specific task or information retrieval. The instruction seeking desired information may be provided in any level of granularity. In some cases, an instruction may be a general instruction requesting generation of code(s) associated with a task, identification of a particular programming language, and/or the like. In other cases, an instruction may be specific to a problem (e.g., based on a request or input provided by a user). For instance, a user may specify a desire to understand information or perform a data transformation or calculation, etc.

To generate a prompt that is suitable to generate a desired AI response, the prompt generator 240 may use relevant code resource data, for example, identified via code resource data manager 222. For example, in one embodiment, relevant code resource data of a first type identified via the driver retriever 230 and relevant code resource data of a second type identified via the influenced retriever 232 may be used to generate a prompt. In this way, various types of relevant code resource data may be included or referenced in a prompt for use in generating desired code.

In some cases, a prompt may additionally include relationships or connections between the different types of corresponding code resource data. For example, assume a particular code example is identified as relevant to a particular grammar entity. In such a case, an indication or representation of the related data may be provided in the prompt. Further, in some embodiments, a prompt may be generated to include the input, such as a natural language utterance or query.

Various other types of information may be included in a prompt. For example, a target programming language may be specified in a prompt. As another example, instructions for a type or format of output code may be provided (e.g., a length or structure for which to use in generating the code).

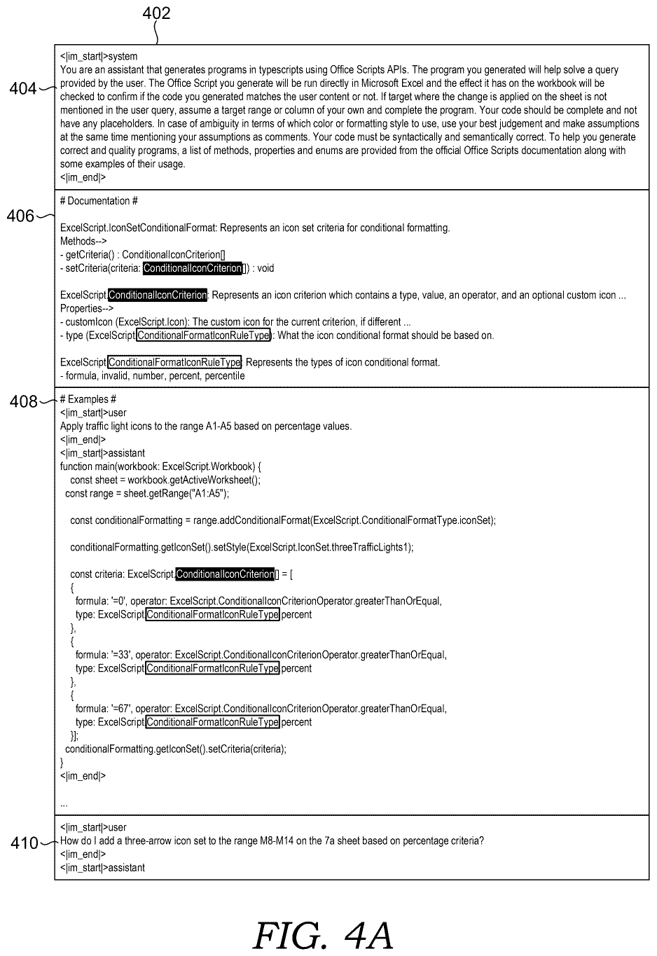

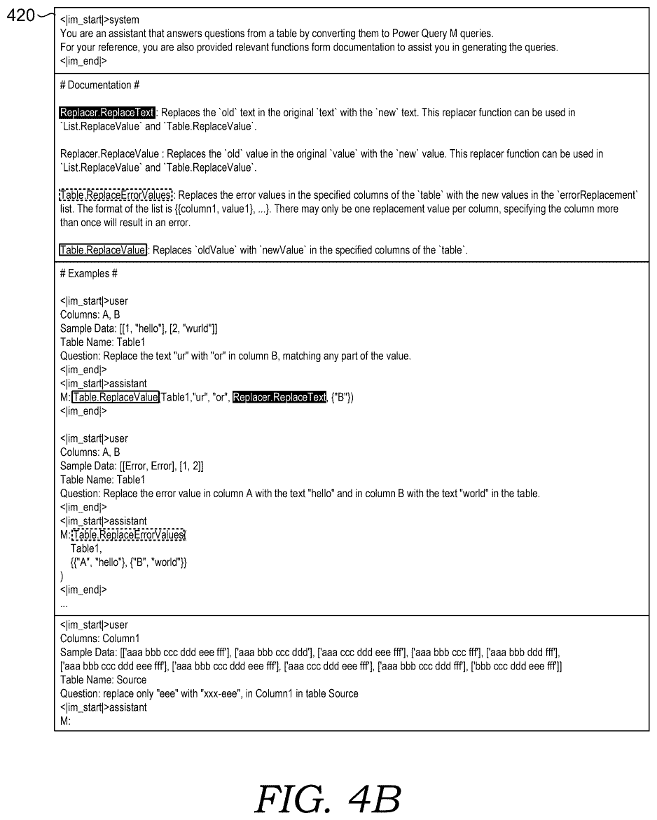

The prompt generator 240 may provide generated prompts to the AI agent 242 to initiate execution of the prompts. In this way, the prompt generator 240 may communicate the generated prompt to AI agent 242 to generate a response thereto. FIGS. 4A and 4B provide example prompts that may be generated and provided to obtain an AI response. These example prompts are provided for illustrative purposes and are not intended to be limiting to aspects of the technology described herein. With initial reference to FIG. 4A, an example prompt 402 is provided that may be provided to an LLM for code generation (e.g., in association with Office Scripts code generation). The example prompt 402 includes an instruction portion 404, a documentation portion 406, a code example portion 408, and a natural language utterance or query portion 410. As such, the documentation portion 406 may include various sets of code resource data, for example in the form of grammar entities, identified as relevant, and the code example portion 408 may include code examples identified as relevant, both of which may be used to generate code. Similarly highlighted portions in the prompt illustrate the match between the code and grammar entities and on how the return type of a grammar entity is mapped to its definition in the same prompt, thereby helping the LLM establish an understanding of the function chaining strategy used in the example program so that it is able to use the right function in the right place where its return type matches. With reference to FIG. 4B, FIG. 4B provides an example prompt 420 that may be provided to an LLM for code generation (e.g., in association with Power Query [PQ] code generation). The code requires the sample data from the table, the table name, and the column headers to write specific code that is executable and also easy to match with the ground truth. The prompt also includes the table metadata for the test query for complete code generation without any assumptions. The documentation structure is uniform throughout and contains only the grammar name and its description. The similar highlights represent the common functionalities between the grammar and the example, which are retrieved during a retrieval-augmented retrieval process.

Returning to FIG. 2, the AI agent 242 is generally configured to facilitate generation of an AI response. An AI response generally refers to a response generated using AI. In this regard, the AI agent 242 may use or access AI technology to facilitate generation of a response to an input prompt. In particular, the prompt may be used by an AI model, such as an LLM, to generate a response to be provided to a user. A response may be in any form. In some cases, the form of a response may depend on a particular desired format included in a prompt. For example, a prompt may request a response in a table format, a paragraph format, a bullet point format, or the like.

The AI agent 242 may use any type of data to generate an AI response. For example, context included in the prompt, such as relevant code resource data, may be used to generate a response in the form of code. In this way, code is generated using code resource data, such as code examples and grammar entities, identified as relevant to a particular input (e.g., natural language utterance or query).

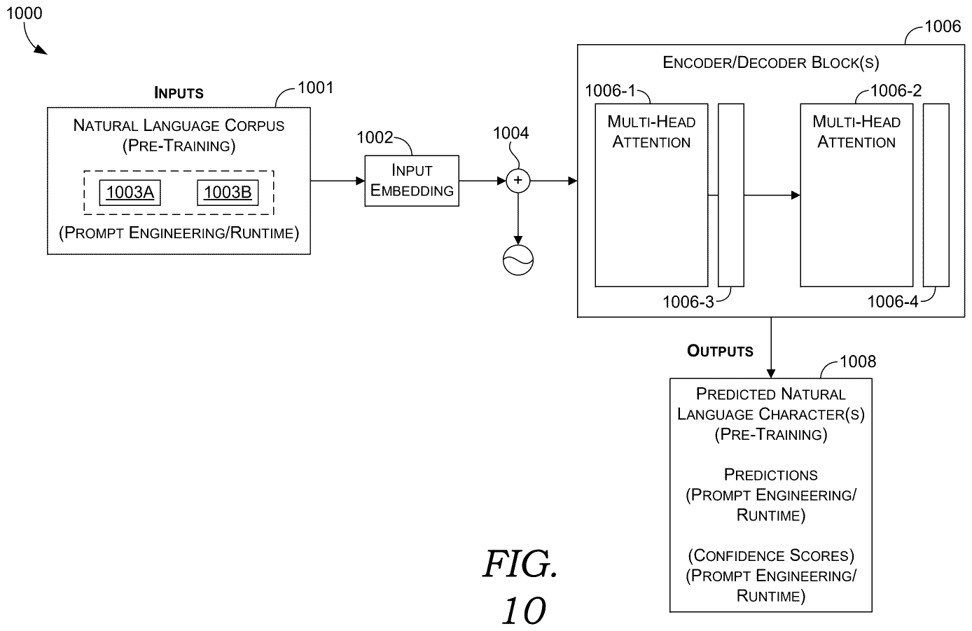

In embodiments, the AI agent 242 may be, include, or access any number of artificial intelligence models or technologies. In some cases, a machine learning model in the form of an LLM is used to generate an AI response. A language model is a statistical and probabilistic tool that determines the probability of a given sequence of words occurring in a sentence (e.g., via next sentence prediction [NSP] or masked language model [MLM]). Simply put, it is a tool that is trained to predict the next word in a sentence. A language model is called a large language model when it is trained on an enormous amount of data. In particular, an LLM refers to a language model including a neural network with an extensive amount of parameters that is trained on an extensive quantity of unlabeled text using self-supervising learning. Oftentimes, LLMs have a parameter count in the billions, or higher. Some examples of LLMs are GOOGLE's BERT and OpenAI's GPT-2, GPT-3, and GPT-4. For instance, GPT-3 is a large language model with 175 billion parameters trained on 570 gigabytes of text. These models have capabilities ranging from writing a simple essay to generating complex computer codes-all with limited to no supervision. Accordingly, an LLM is a deep neural network that is very large (billions to hundreds of billions of parameters) and understands, processes, and produces human natural language by being trained on massive amounts of text. Although some examples provided herein include a single-mode generative model, other models, such as multimodal generative models, are contemplated within the scope of embodiments described herein. Generally, multimodal models are generated to make predictions based on different types of modalities (e.g., text and images). In some embodiments, the AI agent 242 takes on the form of or uses an LLM, but various other artificial intelligence models or technologies can additionally or alternatively be used. One example of an LLM is provided below in reference to FIG. 10. Other models or technology may be used herein, including, but not limited to, small language models.

The data provider 226 is generally configured to provide data, such as AI response data 260. In this regard, the data provider 226 may provide AI response data to the user device that provided the code request 252 to the programming code manager 212. In this way, the data provider 226 provides data to be presented that is relevant to the code request 252. In particular, the user may be presented with an indication of code that represents a desired task. The data provider 226 may provide the AI response to the user device via an appropriate interface (e.g., a chat window, search results page, or the like).

In some cases, the data provider 226 may also provide identified relevant code resource data. In this way, in addition to presenting a response to the prompt generated, the user may also view identified relevant code resource data used to generate a response. The relevant code resource data may be any type of data that is used or generated in the process of generating an AI response. Various types of relevant code resource data that may be provided include code examples, grammar entities, and/or the like.

In some cases, the provided data, such as generated code, may be provided for display. For example, an AI response may indicate a generated code and/or code resource data identified as relevant. Such data may be presented in any number of ways and formats.

In addition or in the alternative to providing AI response data for presentation at a user device, the data provider 226 may provide such data to the user device, another system, component, or machine for further analysis and/or implementation. For example, generated code may be provided to an application in which a user desires to perform a task, and the generated code may be automatically executed to implement the desired functionality.

As one example implementation, assume a driver retriever is configured to retrieve or identify code examples, and an influential retriever is configured to retrieve or identify grammar entities. In such a case, a driver retriever, R_{D}, extracts the top-k examples (Eₖ) based on similarity S(M_{PT}, qₜ, qᵢ), with qₜ representing the target query. Thereafter, the influenced retriever R_{I}, uses Eₖ to select relevant n grammar entities Dₙ. Grammar entities can be extracted from each code snippet cᵢ in an example (qᵢ, cᵢ)∈Eₖ, along with other similar entities from their respective documentation pages using similarity S(M_{FT}, qₜ, J(g)). Such an extracted set forms the good or positive grammar entities D_{good}. In some cases, irrelevant or negative examples may also be retrieved. As such, a grammar element g that is similar to qₜ (Sₜ=S(M_{FT}, qₜ, J(g)) is high) but dissimilar to the selected examples (Sᵢ=S(M_{FT}, qᵢ, J(g)) is low for (qᵢ, cᵢ)∈Eₖ). Such data may be combined into a single score (1−Sᵢ)+λ_{E→D}(1+Sₜ) to maximize for each example i, where λ_{E→D} is a hyper parameter that marks the relative importance of similarity to the query compared to dissimilarity between the examples. This set may be represented as D_{load}. As such, a final set of grammar entities can be represented as D=D_{good}+D_{bad}.

In another example implementation, assume a driver retriever is configured to retrieve or identify grammar entities, and an influential retriever is configured to retrieve or identify code examples using the identified grammar entities. In this example implementation, initially, the driver retriever, R_{D}, extracts top-n grammar entities (Dₙ) using similarity S(M_{FT}, qₜ, J(g)), with qₜ representing the target query. In some cases, successful (E_{good}) and unsuccessful (E_{bad}) retrieval of grammar entities may be considered. To ensure focus on unique grammar entities, an inverse-document frequency of such an entity idf(g) may be determined. Assume Gᵢ represents the grammar entities extracted from code cᵢ. The score of a good example can be computed as the average similarity of its entities, weighted by their idf:

$$\frac{1}{\vert {G}_{i} \vert} {\sum }_{g ∈ {G}_{i} ⋂ {D}_{n}} idf ( g ) \cdot S ( {ℳ}_{FT} , {q}_{t} , J ( g ) ) .$$

For building E_{bad}, it may be assumed that Dₙ does not contain the grammar entities that would be relevant to answer qₜ. The above score can be computed over D\Dₙ as Sⁱ_{bad}. The poor or bad examples may be selected according to Sⁱ_{bad}+λ_{D→E}S(M_{PT}, qₜ, qᵢ), with λ_{D→E} being the importance factor of relevance of query to code examples versus irrelevance of query to selected grammar.

As discussed, various implementations and combinations of technologies may be used to implement various aspects related to identifying relevant code resource data for code generation using enhanced data retrieval. In some cases, the particular technologies employed may depend on the application utilizing such technologies. Further, although generally discussed as identifying relevant code resource data to generate code, other embodiments may include an enhanced data retrieval process to identify various types of data relevant to an input, and such identified relevant data may be analyzed or used to generate a response accordingly.

### Exemplary Implementations for Identifying Relevant Code Resource Data for Code Generation Using Enhanced Data Retrieval

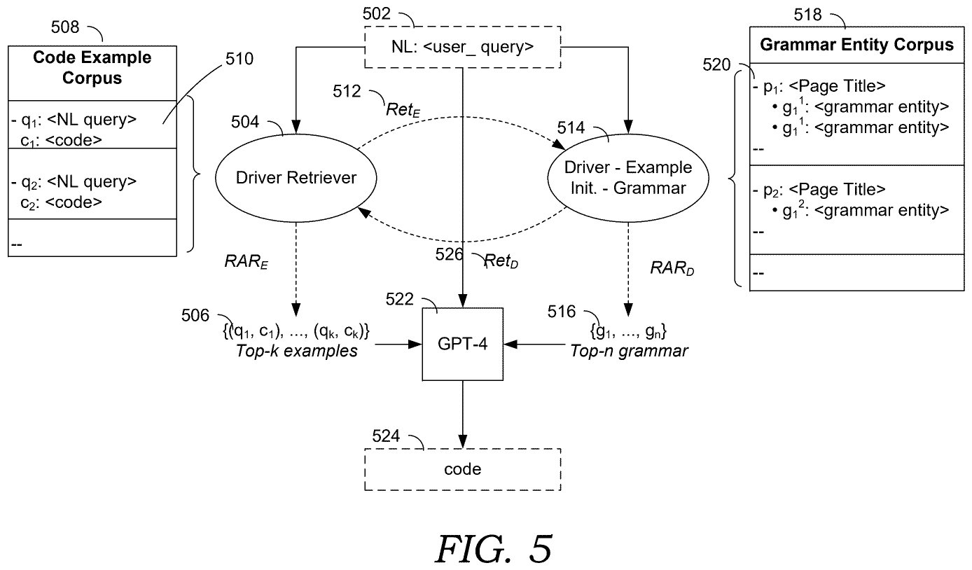

FIG. 5 provides an example flow diagram of one implementation that may be used for implementing embodiments of the present technology. As shown in FIG. 5, an input 502 is obtained. Generally, the input is a user-provided input (e.g., a natural language utterance or query), for example, associated with a desired task to be performed. In some cases, the input may include a target programming language to use for generating code to perform the task. In other cases, a target programming language for generating code may be determined, for instance, based on the application being used, based on the requested task, etc. The user input 502 may be used by a driver retriever 504 to identify, obtain, or retrieve relevant code examples 506 in association with the code example corpus 508. As shown, the code example corpus 508 includes various code example entries, such as code example entry 510. Each code example entry may include a query-code pair, including a natural language query and a corresponding portion of code. Further, each code example entry may be represented via an embedding. In some cases, such an embedding may be generated in advance and stored in association with the code example entry in the code example corpus. In other cases, such an embedding may be generated by the driver retriever 504 as the driver retriever is analyzing the code example corpus to identify relevant code examples.

As illustrated, the relevant code examples, or a portion thereof, represented as Ret_{E} 512, are provided to the influenced retriever 514. The influenced retriever 514 may then use the relevant code examples and the input 502 to identify, obtain, or retrieve relevant grammar entities 516 in association with the grammar entity corpus 518. As shown, the grammar entity corpus 518 includes various grammar entity entries, such as grammar entity entry 520. Each grammar entity entry may include a page title and set of corresponding grammar entities. Further, each grammar entity entry may be represented via an embedding. In some cases, such an embedding may be generated in advance and stored in association with the grammar entity entry in the grammar entity corpus. In other cases, such an embedding may be generated by the influenced retriever 514 as the influenced retriever is analyzing the grammar entity corpus to identify relevant grammar entities.

The identified relevant code examples 506, the relevant grammar entities 516, and the input 502 are provided as input, via a prompt, to a generative AI model 522, such as an LLM, which then produces or outputs code 524 generated in response to the input 502. As described, the code 524 may be provided for display or directly integrated or executed to perform a task as requested by the input.

As can be appreciated, in other embodiments, relevant grammar entities may be initially identified and provided for use in identifying relevant code examples. For example, using the input 502, a set of relevant grammar entities may be identified and provided 526 to an influenced driver for use in identifying a set of relevant code examples that are relevant to the input 502 and the identified set of relevant grammar entities.

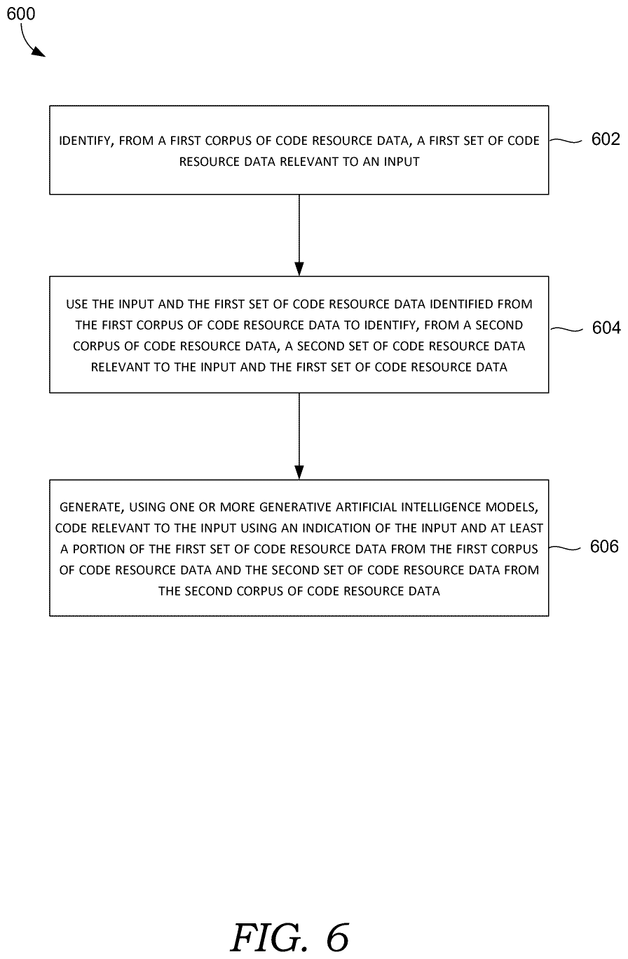

As described, various implementations can be used in accordance with embodiments described herein. FIGS. 6-8 provide methods of identifying relevant code resource data and generating code therefrom, in accordance with embodiments described herein. The methods 600, 700, and 800 can be performed by a computer device, such as device 900 described below. The flow diagrams represented in FIGS. 6-8 are intended to be exemplary in nature and not limiting. For example, flow diagrams represented in FIGS. 6-8 represent various combinations of technologies and approaches used to manage identifying relevant code resource data and/or generating code, but are not intended to reflect all combinations of technologies and approaches that may be used in accordance with embodiments described herein.

With respect to FIG. 6, FIG. 6 provides an example method flow 600 for identifying relevant code resource data and using such data to generate code, in accordance with embodiments described herein. At block 602, a first set of code resource data is identified, from a first corpus of code resource data, as being relevant to an input. The input may be a user query or natural language utterance. In some cases, the input may include an indication of a type of programming language to use to generate the code. The first code of resource data may be identified as being relevant to the input by comparing a representation of the input to representations of code resource data in the first corpus. The first corpus of code resource data may include any type of data, such as code examples or grammar entities.

At block 604, the input and the first set of code resource data identified from the first corpus of code resource data is used to identify, from a second corpus of code resource data, a second set of code resource data relevant to the input and the first set of code resource data. In some embodiments, the second set of code resource data is identified as being relevant to the input and the first set of code resource data by comparing representations of the input and the first set of code resource data to representations of code resource data in the second corpus. The second corpus of code resource data may include any type of data, such as code examples or grammar entities. For instance, in cases in which the first corpus of code resource data contains code examples, then the second corpus of code resource data may include grammar entities.

At block 606, code relevant to the input is generated via one or more generative AI models using an indication of the input and at least a portion of the first set of code resource data from the first corpus of code resource data and the second set of code resource data from the second corpus of code resource data. In one example, generating code may include generating a prompt that includes an indication of the input and the first set of code resource data and the second set of code resource data and, thereafter, providing the prompt as input to the generative AI model(s). The generated code may be provided for display and/or implemented to perform a task or functionality indicated in the input.

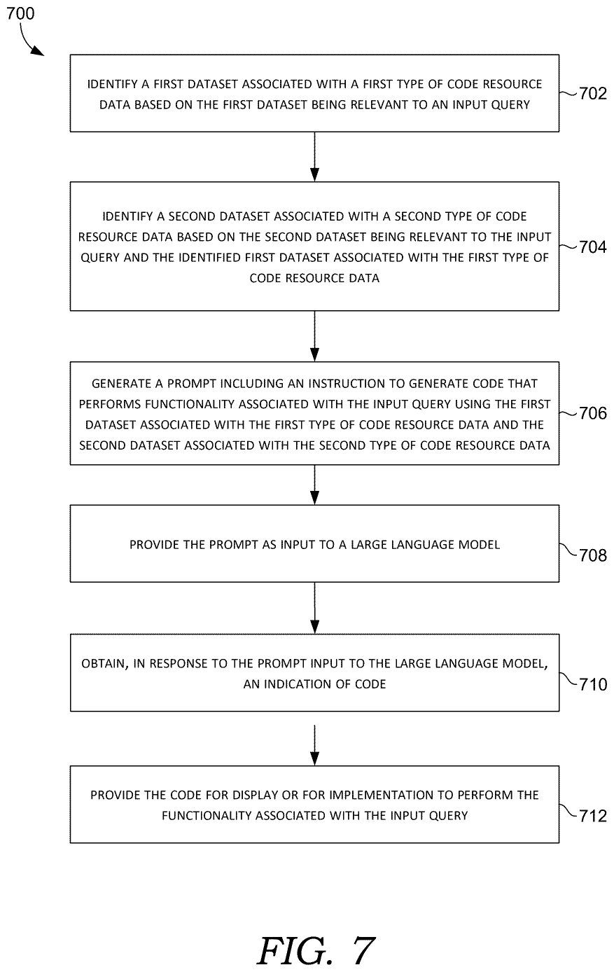

Turning to FIG. 7, FIG. 7 provides an example method flow 700 for identifying relevant code resource data and using such data to generate code, in accordance with embodiments described herein. Initially, at block 702, a first dataset associated with a first type of code resource data is identified based on the first dataset being relevant to an input query. In embodiments, the first dataset associated with the first type of code resource data comprises code examples, and the second dataset associated with the second type of code resource data comprises grammar entities. Such a first dataset may include positive and negative code examples or positive and negative grammar entities.

At block 704, a second dataset associated with a second type of code resource data is identified based on the second dataset being relevant to the input query and the identified first dataset associated with the first type of code resource data. In some cases, an embedding model may be used to generate embeddings and compare embeddings to determine similarity therebetween. In embodiments, the first dataset associated with the first type of code resource data and the second dataset associated with the second type of code resource data correspond to a programming language identified in association with the input query.

At block 706, a prompt is generated and includes an instruction to generate code that performs functionality associated with the input query using the first dataset associated with the first type of code resource data and the second dataset associated with the second type of code resource data. The prompt may further include an indication of a programming language to use for generating code.

At block 708, the prompt is provided as input to an LLM. Thereafter, at block 710, an indication of code is obtained in response to the prompt input to the LLM. In this way, the code is generated using the various identified datasets correlated or dependent on one another. At block 712, the code is provided for display or for implementation to perform the functionality associated with the input query.

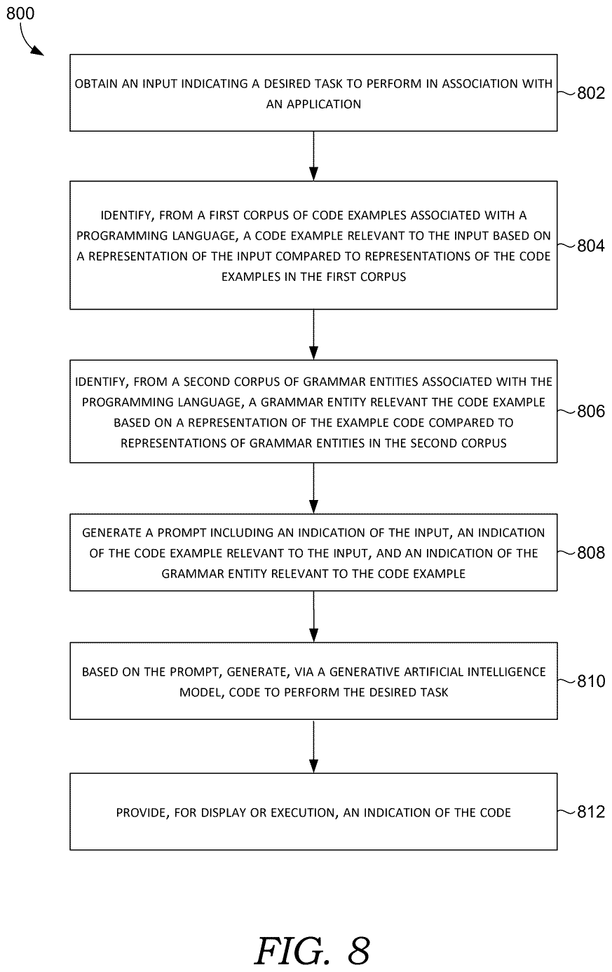

Turning to FIG. 8, FIG. 8 provides an example method flow 800 for identifying relevant code resource data and using such data to generate code, in accordance with embodiments described herein. Initially, at block 802, an input indicating a desired task to perform in association with an application is obtained.

At block 804, a code example relevant to the input is identified, from a first corpus of code examples associated with a programming language, based on a representation of the input compared to representations of the code examples in the first corpus. The input may include an indication of the programming language. A code example may be in various forms. For instance, a code example may be in the form of a query-example pair. In some cases, a model, such as an embedding model, may be used to generate the representation of the input and the representation of the code examples and to determine an extent of similarity between the representation of the input and a representation of the code example. Such a model may be trained, for instance, using sample datasets of sample queries and corresponding samples of code examples and/or grammar entities.

At block 806, a grammar entity relevant to the code example is identified from a second corpus of grammar entities associated with the programming language based on a representation of the example code compared to representations of grammar entities in the second corpus. A representation of the code example may be in the form of an embedding. Such an embedding may embed the code example and, in some cases, the input, or a portion thereof. A grammar entity may, for example, indicate a structure or a syntax associated with writing or interpreting code associated with the programming language.

At block 808, a prompt is generated that includes an indication of the input, an indication of the code example relevant to the input, and an indication of the grammar entity relevant to the code example. A prompt may also include an indication of a programming language to use for generating code.

At block 810, based on the prompt, code to perform the desired task is generated via a generative artificial intelligence model. Thereafter, at block 812, an indication of the code is provided for display or execution.

Accordingly, various aspects of technology are directed to systems, methods, and graphical user interfaces for intelligently identifying relevant code resource data and using such data to generate code. It is understood that various features, subcombinations, and modifications of the embodiments described herein are of utility and may be employed in other embodiments without reference to other features or subcombinations. Moreover, the order and sequences of steps shown in the example methods 600, 700, and 800 are not meant to limit the scope of the present disclosure in any way, and in fact, the steps may occur in a variety of different sequences within embodiments hereof. Such variations and combinations thereof are also contemplated to be within the scope of embodiments of this disclosure.

In some embodiments, a computing system is provided. The computing system can include a processor and computer storage memory having computer-executable instructions stored thereon that, when executed by the processor, configure the computing system to perform operations. In embodiments, the operations include identifying, from a first corpus of code resource data, a first set of code resource data relevant to an input. The operations further include using the input and the first set of code resource data identified from the first corpus of code resource data to identify, from a second corpus of code resource data, a second set of code resource data relevant to the input and the first set of code resource data. The operations further include generating, using one or more generative artificial intelligence models, code relevant to the input using an indication of the input and at least a portion of the first set of code resource data from the first corpus of code resource data and the second set of code resource data from the second corpus of code resource data. Advantageously, identifying and using the relevant code resource data provides a more efficient and effective generation of code, thereby reducing computer resource utilization.

In any combination of the above embodiments of the computing system, the input includes an indication of a type of programming language to use to generate the code.

In any combination of the above embodiments of the computing system, the first set of code resource data is identified as being relevant to the input by comparing a representation of the input to representations of code resource data in the first corpus.

In any combination of the above embodiments of the computing system, the second set of code resource data is identified as being relevant to the input and the first set of code resource data by comparing representations of the input and the first set of code resource data to representations of code resource data in the second corpus.

In any combination of the above embodiments of the computing system, the first corpus of code resource data comprises code examples, and the second corpus of code resource data comprises grammar entities.

In any combination of the above embodiments of the computing system, the first corpus of code resource data comprises grammar entities, and the first corpus of code resource data comprises code examples.

In any combination of the above embodiments of the computing system, generating the code comprises generating a prompt including the indication of the input and the at least the portion of the first set of code resource data from the first corpus of code resource data and the second set of code resource data from the second corpus of code resource data, and providing the prompt as input to the one or more generative artificial intelligence models.

In any combination of the above embodiments of the computing system, the system further comprises causing presentation of the code or implementing the code to perform a task associated with the input.

In other embodiments, a computer-implemented method is provided. The method includes identifying a first dataset associated with a first type of code resource data based on the first dataset being relevant to an input query. The method also includes identifying a second dataset associated with a second type of code resource data based on the second dataset being relevant to the input query and the identified first dataset associated with the first type of code resource data. The method also includes generating a prompt including an instruction to generate code that performs functionality associated with the input query using the first dataset associated with the first type of code resource data and the second dataset associated with the second type of code resource data. The method further includes providing the prompt as input to a large language model. The method also includes obtaining, in response to the prompt input to the large language model, an indication of code. The method also includes providing the code for display or for implementation to perform the functionality associated with the input query. Advantageously, identifying and using the relevant code resource data provides a more efficient and effective generation of code, thereby reducing computer resource utilization.

In any combination of the above embodiments of the computer-implemented method, the first dataset associated with the first type of code resource data comprises code examples, and the second dataset associated with the second type of code resource data comprises grammar entities.

In any combination of the above embodiments of the computer-implemented method, the prompt further includes an indication of a programming language to use for generating the code.

In any combination of the above embodiments of the computer-implemented method, the first dataset associated with the first type of code resource data and the second dataset associated with the second type of code resource data correspond to a programming language identified in association with the input query.

In any combination of the above embodiments of the computer-implemented method, the first dataset associated with the first type of code resource data includes positive and negative code examples or positive and negative grammar entities.

In other embodiments, one or more computer storage media having computer-executable instructions embodied thereon that, when executed by one or more processors, cause the one or more processors to perform a method is provided. The method includes obtaining an input indicating a desired task to perform in association with an application. The method also includes identifying, from a first corpus of code examples associated with a programming language, a code example relevant to the input based on a representation of the input compared to representations of the code examples in the first corpus. The method also includes identifying, from a second corpus of grammar entities associated with the programming language, a grammar entity relevant to the code example based on a representation of the example code compared to representations of grammar entities in the second corpus. The method further includes generating a prompt including an indication of the input, an indication of the code example relevant to the input, and an indication of the grammar entity relevant to the code example. The method further includes based on the prompt, generating, via a generative artificial intelligence model, code to perform the desired task. The method further includes providing, for display or execution, an indication of the code. Advantageously, identifying and using the relevant code resource data provides a more efficient and effective generation of code, thereby reducing computer resource utilization.

In any combination of the above embodiments of the media, the input includes an indication of the programming language.

In any combination of the above embodiments of the media, the representation of the code example comprises an embedding of the code example and at least a portion of the input.

In any combination of the above embodiments of the media, the code example comprises a query and a corresponding portion of code representing an example associated with the query.

In any combination of the above embodiments of the media, the grammar entity indicates a structure or a syntax associated with writing or interpreting code associated with the programming language.

In any combination of the above embodiments of the media, the method further comprises using a model to generate the representation of the input and the representations of the code example in the first corpus and to determine an extent of similarity between the representation of the input and a representation of the code example.

In any combination of the above embodiments of the media, the method further comprises training the model using sample datasets of sample queries and corresponding samples of code examples and/or grammar entities.

### Overview of Exemplary Operating Environments

Having briefly described an overview of aspects of the technology described herein, an exemplary operating environment in which aspects of the technology described herein may be implemented is described below in order to provide a general context for various aspects of the technology described herein.

Referring to the drawings in general, and to FIG. 9 in particular, an exemplary operating environment for implementing aspects of the technology described herein is shown and designated generally as computing device 900. Computing device 900 is just one example of a suitable computing environment and is not intended to suggest any limitation as to the scope of use or functionality of the technology described herein, and nor should the computing device 900 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 9, computing device 900 includes a bus 910 that directly or indirectly couples the following devices: memory 912, one or more processors 914, one or more presentation components 916, input/output (I/O) ports 918, I/O components 920, an illustrative power supply 922, and a radio(s) 924. Bus 910 represents what may be one or more buses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The diagram of FIG. 9 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 9 and refer to “computer” or “computing device.”

Computing device 900 typically includes a variety of computer-readable media. Computer-readable media can be any available media that can be accessed by computing device 900 and includes both volatile and non-volatile, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVDs) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 912 includes computer storage media in the form of volatile and/or non-volatile memory. The memory 912 may be removable, non-removable, or a combination thereof. Exemplary memory includes solid-state memory, hard drives, and optical-disc drives. Computing device 900 includes one or more processors 914 that read data from various entities such as bus 910, memory 912, or I/O components 920. Presentation component(s) 916 present data indications to a user or other device. Exemplary presentation components 916 include a display device, speaker, printing component, and vibrating component. I/O port(s) 918 allow computing device 900 to be logically coupled to other devices including I/O components 920, some of which may be built-in.

Illustrative I/O components include a microphone, joystick, game pad, satellite dish, scanner, printer, display device, wireless device, a controller (such as a keyboard and a mouse), a natural user interface (NUI) (such as touch interaction, pen [or stylus] gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 914 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 900. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 900. The computing device 900 may be equipped with depth cameras, such as stereoscopic camera systems, infrared camera systems, RGB camera systems, and combinations of these, for gesture detection and recognition. Additionally, the computing device 900 may be equipped with accelerometers or gyroscopes that enable detection of motion. The output of the accelerometers or gyroscopes may be provided to the display of the computing device 900 to render immersive augmented reality or virtual reality.

A computing device may include radio(s) 924. The radio 924 transmits and receives radio communications. The computing device may be a wireless terminal adapted to receive communications and media over various wireless networks. Computing device 900 may communicate via wireless protocols, such as code-division multiple access (“CDMA”), Global System for Mobiles (“GSM”), or time-division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

Turning to FIG. 10, FIG. 10 is a block diagram of a language model 1000 (for example, a BERT model or Generative Pre-trained Transformer [GPT]-4 model) that uses particular inputs to make particular predictions (for example, answers to questions), according to some embodiments. In one embodiment, the language model 1000 corresponds to the AI agent 242 of FIG. 2 described herein. In various embodiments, the language model 1000 includes one or more encoders and/or decoder blocks 1006 (or any transformer or portion thereof).

First, a natural language corpus (for example, various WIKIPEDIA English words or BooksCorpus) of the inputs 1001 are converted into tokens and then feature vectors and embedded into an input embedding 1002 to derive meaning of individual natural language words (for example, English semantics) during pre-training. In some embodiments, to understand English language, corpus documents, such as text books, periodicals, blogs, social media feeds, and the like are ingested by the language model 1000.

In some embodiments, each word or character in the input(s) 1001 is mapped into the input embedding 1002 in parallel or at the same time, unlike existing long short-term memory (LSTM) models, for example. The input embedding 1002 maps a word to a feature vector representing the word. But the same word (for example, “apple”) in different sentences may have different meanings (for example, brand versus fruit). This is why a positional encoder 1004 can be implemented. A positional encoder 1004 is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sine/cosine function to generate the positional encoder vector using the following two example equations:

$${PE}_{( pos , 2 i )} = sin ( pos / {10000}^{2 i / {d}_{model}} ) \qquad ( 1 )$$

$${PE}_{( pos , 2 i + 1 )} = cos ( pos / {10000}^{2 i / {d}_{model}} ) . \qquad ( 2 )$$

After passing the input(s) 1001 through the input embedding 1002 and applying the positional encoder 1004, the output is a word embedding feature vector, which encodes positional information or context based on the positional encoder 1004. These word embedding feature vectors are then passed to the encoder and/or decoder block(s) 1006, where it goes through a multi-head attention layer 1006-1 and a feedforward layer 1006-2. The multi-head attention layer 1006-1 is generally responsible for focusing or processing certain parts of the feature vectors representing specific portions of the input(s) 1001 by generating attention vectors. For example, in Question Answering systems, the multi-head attention layer 1006-1 determines how relevant the i^{th} word (or particular word in a sentence) is for answering the question or how relevant it is to other words in the same or other blocks, the output of which is an attention vector. For every word, some embodiments generate an attention vector, which captures contextual relationships between other words in the same sentence or other sequences of characters. For a given word, some embodiments compute a weighted average or otherwise aggregate attention vectors of other words that contain the given word (for example, other words in the same line or block) to compute a final attention vector.

In some embodiments, a single-headed attention has abstract vectors Q, K, and V that extract different components of a particular word. These are used to compute the attention vectors for every word, using the following equation (3):

$$Z = softmax ( \frac{Q \cdot {K}^{T}}{\sqrt{Dimension of vector Q , K or V}} ) \cdot V . \qquad ( 3 )$$

For multi-headed attention, there are multiple weight matrices W^{q}, W^{k}, and W^{v}, so there are multiple attention vectors Z for every word. However, a neural network may expect one attention vector per word. Accordingly, another weighted matrix, W^{z}, is used to make sure the output is still an attention vector per word. In some embodiments, after the layers 1006-1 and 1006-2, there is some form of normalization (for example, batch normalization and/or layer normalization) performed to smoothen out the loss surface, making it easier to optimize while using larger learning rates.

Layers 1006-3 and 1006-4 represent residual connection and/or normalization layers where normalization recenters and rescales or normalizes the data across the feature dimensions. The feedforward layer 1006-2 is a feedforward neural network that is applied to every one of the attention vectors outputted by the multi-head attention layer 1006-1. The feedforward layer 1006-2 transforms the attention vectors into a form that can be processed by the next encoder block or make a prediction at 1008. For example, given that a document includes a first natural language sequence “the due date is . . . ,” the encoder/decoder block(s) 1006 predicts that the next natural language sequence will be a specific date or particular words based on past documents that include language identical or similar to the first natural language sequence.

In some embodiments, the encoder/decoder block(s) 1006 includes pre-training to learn language (pre-training) and make corresponding predictions. In some embodiments, there is no fine-tuning because some embodiments perform prompt engineering or learning. Pre-training is performed to understand language, and fine-tuning is performed to learn a specific task, such as learning an answer to a set of questions (in Question-Answering [QA] systems).

In some embodiments, the encoder/decoder block(s) 1006 learns what language and context for a word is in pre-training by training on two unsupervised tasks (Masked Language Model [MLM] and Next Sentence Prediction [NSP]) simultaneously or at the same time. In terms of the inputs and outputs, at pre-training, the natural language corpus of the inputs 1001 may be various historical documents, such as text books, journals, and periodicals, in order to output the predicted natural language characters in 1008 (not make the predictions at runtime or prompt engineering at this point). The example encoder/decoder block(s) 1006 takes in a sentence, paragraph, or sequence (for example, included in the input[s] 1001), with random words being replaced with masks. The goal is to output the value or meaning of the masked tokens. For example, if a line reads, “please [MASK] this document promptly,” the prediction for the “mask” value is “send.” This helps the encoder/decoder block(s) 1006 understand the bidirectional context in a sentence, paragraph, or line at a document. In the case of NSP, the encoder/decoder block(s) 1006 takes, as input, two or more elements, such as sentences, lines, or paragraphs, and determines, for example, if a second sentence in a document actually follows (for example, is directly below) a first sentence in the document. This helps the encoder/decoder block(s) 1006 understand the context across all the elements of a document, not just within a single element. Using both of these together, the encoder/decoder block(s) 1006 derives a good understanding of natural language.

In some embodiments, during pre-training, the input to the encoder/decoder block(s) 1006 is a set (for example, two) of masked sentences (sentences for which there are one or more masks), which could alternatively be partial strings or paragraphs. In some embodiments, each word is represented as a token, and some of the tokens are masked. Each token is then converted into a word embedding (for example, 1002). At the output side is the binary output for the next sentence prediction. For example, this component may output 1, for example, if masked sentence 2 follows (for example, is directly beneath) masked sentence 1. The outputs are word feature vectors that correspond to the outputs for the machine learning model functionality. Thus, the number of word feature vectors that are input is the same number of word feature vectors that are output.

In some embodiments, the initial embedding (for example, the input embedding 1002) is constructed from three vectors: the token embeddings, the segment or context-question embeddings, and the position embeddings. In some embodiments, the following functionality occurs in the pre-training phase. The token embeddings are the pre-trained embeddings. The segment embeddings are the sentence numbers (that includes the input[s] 1001) that are encoded into a vector (for example, first sentence, second sentence, and so forth, assuming a top-down and right-to-left approach). The position embeddings are vectors that represent the position of a particular word in such a sentence that can be produced by positional encoder 1004. When these three embeddings are added or concatenated together, an embedding vector is generated that is used as input into the encoder/decoder block(s) 806. The segment and position embeddings are used for temporal ordering since all of the vectors are fed into the encoder/decoder block(s) 1006 simultaneously, and language models need some sort of order preserved.

In pre-training, the output is typically a binary value C (for NSP) and various word vectors (for MLM). With training, a loss (for example, cross-entropy loss) is minimized. In some embodiments, all the feature vectors are of the same size and are generated simultaneously. As such, each word vector can be passed to a fully connected layered output with the same number of neurons equal to the same number of tokens in the vocabulary.

In some embodiments, after pre-training is performed, the encoder/decoder block(s) 1006 performs prompt engineering or fine-tuning on a variety of QA data sets by converting different QA formats into a unified sequence-to-sequence format. For example, some embodiments perform the QA task by adding a new question-answering head or encoder/decoder block, just the way a masked language model head is added (in pre-training) for performing an MLM task, except that the task is a part of prompt engineering or fine-tuning. This includes the encoder/decoder block(s) 1006 processing the inputs 1003A and/or 1003B in order to make the predictions and generate a prompt response, as indicated in 1004. Prompt engineering, in some embodiments, is the process of crafting and optimizing text prompts for language models to achieve desired outputs. In other words, prompt engineering comprises a process of mapping prompts (for example, a question) to the output (for example, an answer) that it belongs to for training. For example, if a user asks a model to generate a poem about a person fishing on a lake, the expectation is it will generate a different poem each time. Users may then label the output or answers from best to worst. Such labels are an input to the model to make sure the model is giving more human-like or best answers, while trying to minimize the worst answers (for example, via reinforcement learning). In some embodiments, a “prompt” as described herein includes one or more of: a request (for example, a question or instruction [for example, “write a poem”]), target content, and one or more examples, as described herein.

The technology described herein has been described in relation to particular aspects, which are intended in all respects to be illustrative rather than restrictive.

What is claimed is:

1. A computing system comprising:
a processor; and
computer storage memory having computer-executable instructions stored thereon that, when executed by the processor, configure the computing system to perform operations comprising:
identifying, from a first corpus of code resource data, a first set of code resource data relevant to an input;
using the input and the first set of code resource data identified from the first corpus of code resource data to identify, from a second corpus of code resource data, a second set of code resource data relevant to the input and the first set of code resource data; and
generating, using one or more generative artificial intelligence models, code relevant to the input using an indication of the input and at least a portion of the first set of code resource data from the first corpus of code resource data and the second set of code resource data from the second corpus of code resource data.

2. The computing system of claim 1, wherein the input includes an indication of a type of programming language to use to generate the code.

3. The computing system of claim 1, wherein the first set of code resource data is identified as relevant to the input by comparing a representation of the input to representations of code resource data in the first corpus.

4. The computing system of claim 1, wherein the second set of code resource data is identified as relevant to the input and the first set of code resource data by comparing representations of the input and the first set of code resource data to representations of code resource data in the second corpus.

5. The computing system of claim 1, wherein the first corpus of code resource data comprises code examples, and the second corpus of code resource data comprises grammar entities.

6. The computing system of claim 1, wherein the first corpus of code resource data comprises grammar entities, and the first corpus of code resource data comprises code examples.

7. The computing system of claim 1, wherein generating the code comprises:
generating a prompt including the indication of the input and the at least the portion of the first set of code resource data from the first corpus of code resource data and the second set of code resource data from the second corpus of code resource data; and
providing the prompt as input to the one or more generative artificial intelligence models.

8. The computing system of claim 1, further comprising causing presentation of the code or implementing the code to perform a task associated with the input.

9. A computer-implemented method comprising:
identifying a first dataset associated with a first type of code resource data based on the first dataset being relevant to an input query;
identifying a second dataset associated with a second type of code resource data based on the second dataset being relevant to the input query and the identified first dataset associated with the first type of code resource data;
generating a prompt including an instruction to generate code that performs functionality associated with the input query using the first dataset associated with the first type of code resource data and the second dataset associated with the second type of code resource data;
providing the prompt as input to a large language model;
obtaining, in response to the prompt input to the large language model, an indication of code; and
providing the code for display or for implementation to perform the functionality associated with the input query.

10. The computer-implemented method of claim 9, wherein the first dataset associated with the first type of code resource data comprises code examples, and the second dataset associated with the second type of code resource data comprises grammar entities.

11. The computer-implemented method of claim 9, wherein the prompt further includes an indication of a programming language to use for generating the code.

12. The computer-implemented method of claim 9, wherein the first dataset associated with the first type of code resource data and the second dataset associated with the second type of code resource data correspond to a programming language identified in association with the input query.

13. The computer-implemented method of claim 9, wherein the first dataset associated with the first type of code resource data includes positive and negative code examples or positive and negative grammar entities.

14. One or more computer storage media having computer-executable instructions embodied thereon that, when executed by one or more processors, cause the one or more processors to perform a method, the method comprising:
obtaining an input indicating a desired task to perform in association with an application;
identifying, from a first corpus of code examples associated with a programming language, a code example relevant to the input based on a representation of the input compared to representations of the code examples in the first corpus;
identifying, from a second corpus of grammar entities associated with the programming language, a grammar entity relevant to the code example based on a representation of the example code compared to representations of grammar entities in the second corpus;
generating a prompt including an indication of the input, an indication of the code example relevant to the input, and an indication of the grammar entity relevant to the code example;
based on the prompt, generating, via a generative artificial intelligence model, code to perform the desired task; and
providing, for display or execution, an indication of the code.

15. The media of claim 14, wherein the input includes an indication of the programming language.

16. The media of claim 14, wherein the representation of the code example comprises an embedding of the code example and at least a portion of the input.

17. The media of claim 14, wherein the code example comprises a query and a corresponding portion of code representing an example associated with the query.

18. The media of claim 14, wherein the grammar entity indicates a structure or a syntax associated with writing or interpreting code associated with the programming language.

19. The media of claim 14, further comprising using a model to generate the representation of the input and the representations of the code example in the first corpus and to determine an extent of similarity between the representation of the input and a representation of the code example.

20. The media of claim 19, further comprising training the model using sample datasets of sample queries and corresponding samples of code examples and/or grammar entities.
